(19) United States
(12) Patent Application Publication
(10) Pub. No.: US 2018/0169844 A1
(43) Pub. Date: Jun. 21, 2018

(54) FASTENER LABELING DEVICE AND METHOD

(71) Applicant: GENERAL ELECTRIC COMPANY, Schenectady, NY (US)

(72) Inventors: Daniel Nemecek, Waukesha, WI (US); Jimmie Autrey Beacham, West Allis, WI (US)

(21) Appl. No.: 15/381,900

(22) Filed: Dec. 16, 2016

(51) Int. Cl. B25B 23/15; G09F 3/00; B25B 23/142; G06K 19/06; G06K 19/07

(52) U.S. Cl. CPC B25B 23/15; G09F 3/0297; G06K 19/0723; B25B 23/1427; G06K 19/06028; B25B 23/1425

(57) ABSTRACT

A fastener torque-application and marking tool and method. An example embodiment relates to a fastener marking method comprising the steps of rotating a fastener with a torque-application device, stopping the rotation of the fastener, determining the torque value of the fastener, and marking the fastener or adjacent surface with a marking mechanism attached to the torque-application device. In another embodiment, a fastener torque application and marking tool system comprises a torque application device configured to rotate a fastener, a measuring mechanism attached to the torque application device, a marking mechanism attached to the torque-application device, and a reader that reads a unique identifier and confirms proper torqueing. In another embodiment, a torque application and marking tool comprises a handle, a driver, a fastener engaging component, a torque control, and a marking mechanism.

### BACKGROUND

Joining two or more parts together for use in an apparatus often requires some means of fastening the parts in either a static or dynamic configuration. Often two or more pieces of the same or different materials are required to be joined using techniques that, once performed, do not lend themselves to manual inspection or easy verification of proper installation. In many situations, these joints are often key elements of machinery that, should joint failure occur, would risk equipment destruction and/or bystander injury. An example non-verifiable joining process is the application of torque to a screw-type fastener.

Traditional practice for securing and marking a screw-type fastener to a set torque value requires an operator to utilize separate tools to secure the fastener to the correct torque value and then manually mark either the fastener head or an adjacent surface as a means to verify that the fastener was installed with the correct torque applied. Subsequent tools for torque application integrated a host of features among them: torque-sensing, fastener angle sensing, and data-recording.

Screw-type fasteners often secure high-risk joints that are reliant upon proper installation and maintenance of the fastener either due to restrained energy (potential or dynamic), or the potential for human injury. These joints are often described as “critical to safety” or “essential to safety” joints. These joints require evidence that the correct torque was applied at the time of installation, after repairs, and during subsequent maintenance inspections. Example high risk joints can include: those that secure components to the rotational side of computed tomography medical equipment where rotational acceleration can exceed 680 m s⁻²; joints that fasten X-ray tubes to portable X-ray systems (the system is suspended above a patient, joint failure risks injury); and automotive, military, and space applications with bolted joints that clamp parts of significant mass under loads creating a failure mode that could be catastrophic. Skilled practitioners will recognize many other instances too numerous to catalog here where similar joints occur.

Use of screw-type fasteners is but one example of a non-verifiable joint process. Those skilled in the art can recognize many analogous processes and tools engaged in the creation and formation of joints. For example, wire welding, requires keeping track of numerous process variables such as: wire feed rate, material temperature, gas envelope integrity, and current flow. In similar vein, a plasma or arc welder must keep track of variables unique to their joint formation process. Joints may also be formed by deformation of parts into each other, or through the formation and execution of complex geometries. Other example non-verifiable processes can include: spot welding, thermal melting, adhesive applications, etc. These processes all have in common a tool which engages with the joint compositional elements and which then must fasten the elements together in a way that forms a static or dynamic joint.

In order to maintain reliability and accountability for high-risk joints, traditional practice relies upon manufacturers, operators, inspectors, and repair technicians to provide, maintain, and update extensive documentation accompanying the associated machinery, including information relating to each high-risk joint. Thus, there is need to provide direct documentation and evidence on the joint components that manufacturing and maintenance requirements are satisfied. There is further need to automatically maintain associated records documenting joint history.

### BRIEF DESCRIPTION

The term “non-verifiable process,” as used herein, refers to a process, or processes, wherein the compositional elements of a joint are engaged by a tool which then forms, or fastens, a static or dynamic joint. Exemplary non-limiting examples of “non-verifiable processes,” in addition to those provided above, can include any process wherein external validation is applied to the formed joint, thus certifying it usable for an intended purpose. A “process characteristic” can be any variable that a joint formation tool, a sub-component of a joint formation tool, or a separate instrument, measures to determine, and subsequently validate, that the steps of a non-verifiable process were performed and/or performed to within a specified range. A process characteristic may be an indicator of “joint quality;” which is a common usage of the term to represent the fitness of a joint for a specified purpose. A “joint formation tool” is a tool engaged in a non-verifiable process that may include a “fastener engaging component.” The “fastener engaging component” refers to the element of the tool directly engaged in the formation of a joint.

For example, in the case of the application of a screw-type fastener to a joint, the “fastener engagement component” would be the portion of a torque-applying joint formation tool engaged in manipulating a bolt and/or nut. In the case of a welding process, the term “fastener engaging component” may refer to a welding electrode, or similar component engaged in the joint formation. Practitioners in their respective arts will readily recognize those elements of a tool directly engaged in joint formation, thus creating a “fastener engagement component.”

As used herein the term “torque-applying tool” refers to any tool that may be used to apply torque to an object. By way of exemplary non-limiting examples, such tools include tools such as: levers, torque wrenches, air ratchets, ratchets, and tools with a similar objective. The term “torque” refers to not only the basic physical concept of rotational force, but also to values by which the strength of joints and screw-type fasteners are specified and evaluated. The terms “fastener” and “screw-type fastener” when paired with a torque-application tool are synonymous but not identical and encompass both singular and plural elements. In a broad sense, they refer to mechanical means of securing a joint wherein torque must be applied to at least one fastener element. The term “fastener element,” in general, describes a sub-component of a “fastener.” By way of exemplary non-limiting example, a bolt and nut may either be individually or simultaneously rotated through the application of torque in order to secure a joint. Alternatively, a “fastener” may merely be a singular rotating element with or without a pre-existing receptacle for the fastener (i.e., a self-tapping screw, a screw in a pre-tapped hole). Use of either term contemplates the other and does not limit to singular or multiple elements.

In the context of a plate welding process, the term “fastener element” might refer to either plate that might be joined, the electrode and/or fill material, etc. Thus the term “fastener element,” as noted above, is a context dependent generic descriptor meant to encompass the appropriate sub-elements of multiple joining techniques and processes. Further, in the welding context, the term “fastener,” rather than referring to the nut and bolt above, would refer to the materials engaged to form the joint (i.e., electrode, fill, wire, plates, etc.). In this context the joint-formation tool is used to meld the materials together into the joint (welder). Thus, a “fastener engaging component” would be a portion of a joint-formation tool directly engaged in the formation of the joint, “fastening” the materials together. Those skilled in the art, can thus readily recognize their respective joint-formation tools, fasteners, fastener elements, and fastener engaging components for their respective non-verifiable processes.

The term “labeling device” or “marking device” refers to a component of a joint-formation tool capable of applying marks to a fastener element, the joint itself, or an adjacent surface either singly, simultaneously, or iteratively. The terms “surface,” “adjacent surface,” or “medium” refer to those components and elements of a joint outside of the fastener that compose the rest of a joint secured by a fastener. The terms “label,” “mark,” and “identifying mark” are synonymous and contemplate mechanical, electrical, and digital means of applying information to a fastener or another element of a joint.

One embodiment is a method of labeling a fastener containing at least the steps of applying torque to a fastener element with a torque-applying tool; stopping the application of torque at a threshold level; sensing the applied torque; and, labeling the fastener element or adjacent surface with a labeling device integrated with the torque-applying tool.

Another embodiment contains a torque-application and marking tool configured to engage and rotate a fastener element; a labeling device attached to a torque-application tool configured to label at least one of a fastener element and/or adjacent surface when a desired torque is applied; and, a reader that records the marking and confirms the proper application of torque.

Another embodiment is demonstrated via a torque-application and marking tool that comprises a handle including a grip, a drive, a fastener-element engaging component, a torque control, and a labeling device. The torque control communicates with the fastener-element engaging component to set and/or sense that a fastener is at a desired torque value or within a desired range of values. The labeling device communicates with the torque control and applies a mark to the fastener element and/or an adjacent surface after verification the fastener is torqued to either the desired torque value or within the desired torque range. The mark indicates that the fastener was set at the desired torque value or within the desired torque range.

### BRIEF DESCRIPTION OF THE DRAWINGS

Other objects, advantages and novel features of the exemplary non-limiting embodiments presented herein will become apparent from the following detailed description when considered in conjunction with the accompanying drawings, in which like characters represent like parts throughout the drawings, wherein:

FIG. 1 is a schematic of a torque-applying and labeling tool.

FIG. 2 is a schematic including a fastener and reader.

FIG. 3 is a top view schematic of a torque-applying tool.

FIG. 4 is a schematic including a torque control.

FIG. 5 is a schematic of a manual torque-application tool.

FIG. 6 is a schematic of a fastener labeling device and an external data storage unit.

FIG. 7 is a top view schematic of a fastener and an adjacent medium. The fastener is marked with a unique identifier.

FIG. 8 is a top view schematic of a fastener and an adjacent surface. The adjacent surface is marked with a unique identifier.

FIG. 9 is a side view schematic of a fastener and adjacent medium. The fastener is marked with a unique identifier.

FIG. 10 is a schematic of a fastener and an adjacent medium where a unique RFID tag is attached to the fastener.

FIG. 11 is a flow chart of an exemplary method for labeling a fastener and adjacent surface.

FIG. 12 is a flow chart of an exemplary method for labeling a fastener or adjacent medium with a unique identifier.

### DETAILED DESCRIPTION

In the following, the present invention will be described in more detail with reference to illustrative non-limiting embodiments and to accompanying drawings. For purposes of explanation and not limitation, specific details are set forth in the illustrative embodiments, such as particular systems, structures and techniques, etc., in order to enable those skilled in the art to readily understand the present invention. In this context some embodiments demonstrate joint-formation tools for use with a screw-type fastening system. However, it will be apparent to those skilled in the art that the present the illustrative embodiments may be practiced in other embodiments without these specific details described herein. In some aspects, the embodiments presented herein relate to systems and methods of joint formation tools wherein fasteners or adjacent surfaces/media are marked. Some further embodiments are described herein with respect to electronically equipped torque wrenches. Practitioners skilled in the art, however, will readily recognize the applicability and scope of the illustrative embodiments to cover other areas where torque is applied to fasteners and other joint formation tools as above defined.

Exemplary non-limiting embodiments relate to a joint formation, non-verifiable joining process validation, and joint marking tool, and a method for use thereof. Further example embodiments relate to a torque application and marking tool and a method for use thereof.

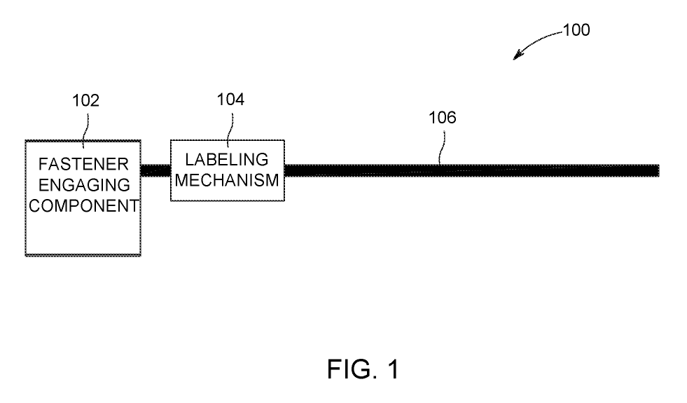

FIG. 1 is a schematic of a torque-applying and marking tool 100 that comprises a handle 106, labeling mechanism 104, and fastener element engaging component 102. The labeling mechanism 104 is configured to label a fastener (e.g. any form of fastener, mechanical or otherwise, which one of ordinary skill in the art would recognize as being rotatable, tightened and/or torqued to fasten materials or objects such as a nut, screw, bolt, rivet, pin, nail, tack, etc.) and/or adjacent surface or medium with a unique identifier. The fastener element engaging component 102 comprises an integral fastening element (not shown) or is configured to engage or otherwise connect to a separate fastening element (not shown), said fastening element (integral or separate) being configured to engage the fastener to enable rotation or torqueing of the fastener until either a desired torque value is reached or a torque value is reached within a desired torque range. Exemplary non-limiting embodiments of the integral or separate fastening element include, but are not limited to, sockets, screwdriver bits, driver bits, tension straps, wrench heads, plier heads, etc., in any shape, form or configuration, or any other known device, mechanical or otherwise, recognized by one of ordinary skill in the art as being capable engaging a fastener to enable a torqueing, tightening and/or loosening of said fastener. The labeling mechanism 104 can either protrude from the handle or be embedded within the handle of the torque-applying tool 100.

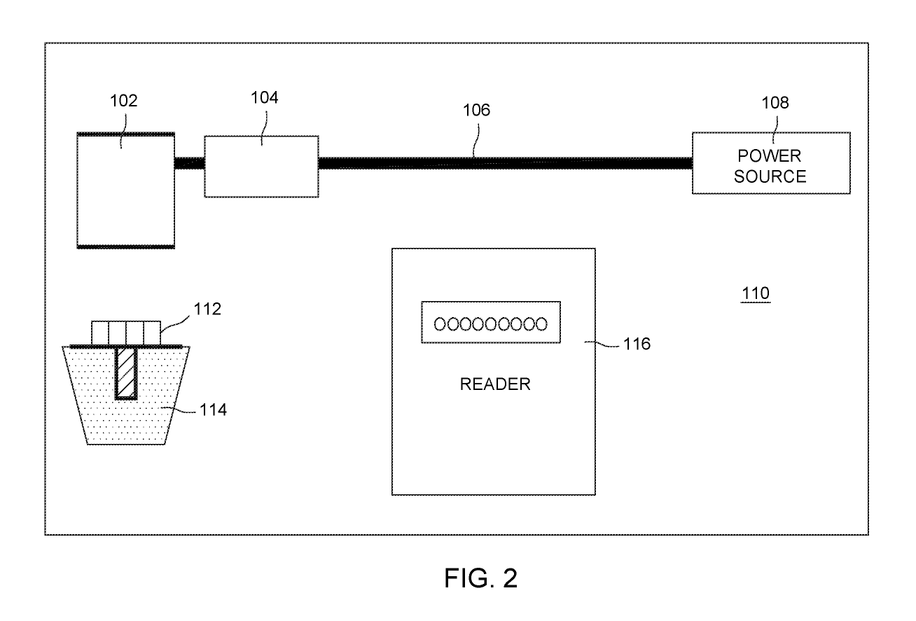

FIG. 2 is a schematic of a fastener marking device system 110 that comprises a torque applying and marking tool comprising a handle 106, labeling mechanism 104, fastener element engaging component 102, and at least one power source 108. Power source 108 may power the labeling mechanism 104, the fastener element engaging component 102, or both in combination. The labeling mechanism 104 can protrude from the handle of the tool or it can be embedded within the handle of the tool. Fastener 112 is attached to an adjacent medium 114. Reader 116 scans a mark (not shown) and determines a data set of information associated with the mark. The data set of information may be stored in the fastener labeling device 104, reader 116, or external storage device 402. An operator acquires a set of data from the reader 116 when the reader scans a mark.

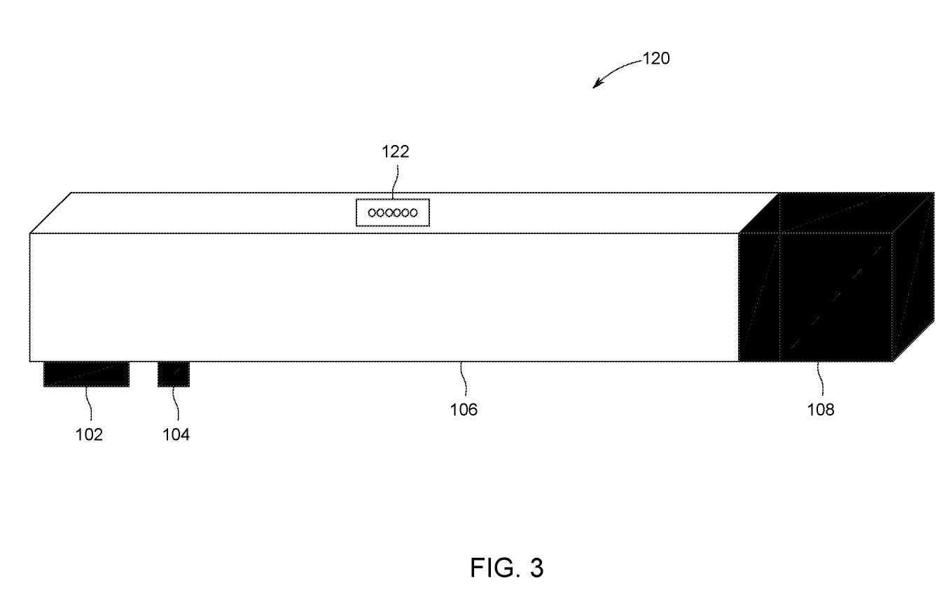

FIG. 3 is a top view of a torque application device 120 that also incorporates a torque control 122. The torque control 122 can be manual or digital. The torque control allows an operator to set and/or program a desired torque value and/or desired torque value range. Digital torque control 122 may be programmed through either direct input of values, or through an interface connected to a computing system (not shown). Manual torque control 122 may either accept a value or range, or it may simply display a current torque value. Torque control 122 in digital or manual form may also be configured to display or accept input values for the fastener labeling device 104.

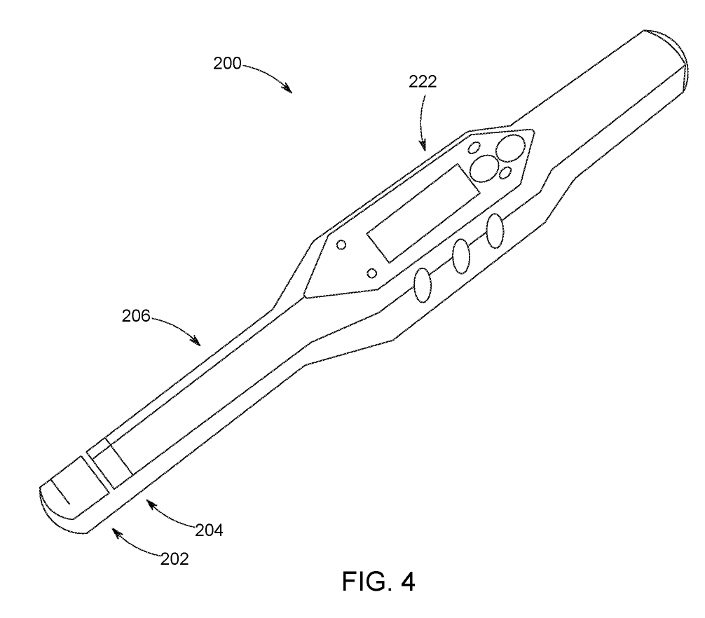

FIG. 4 is a schematic of a digital torque application and marking tool 200 that comprises a fastener element engaging component 202, a labeling mechanism 204, a handle 206, and a digital torque control 222. In this example the digital torque control 222 protrudes from the handle; it may also be streamlined such that it does not alter the diameter or lines of the handle 206. As above, the digital torque control 222 may also accept values and commands for the labeling mechanism 204. Although shown here on one side, digital torque control 222 may also display or contain inputs on multiple sides of handle 206. Further, the digital torque control 222 may have inputs on one side and display / output values on another.

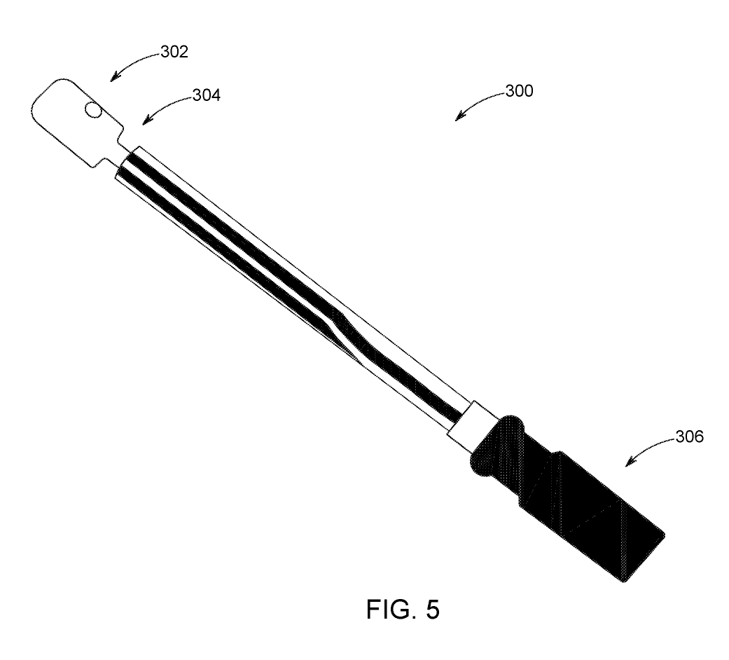

FIG. 5 is a schematic of a manual torque application and marking tool 300 that comprises a fastener engaging component 302, a labeling mechanism 304, and a handle 306. Handle 306 may be used to set a torque value or range and a scale of values may be etched into the handle. Fastener engaging component 302 may interface with screw type fasteners by employing an interchangeable head / component design. Labeling mechanism 304 may be interchangeable as part of the head or as an additional add-on component. Handle 306 may be telescopic to accommodate different ranges of required applied torques.

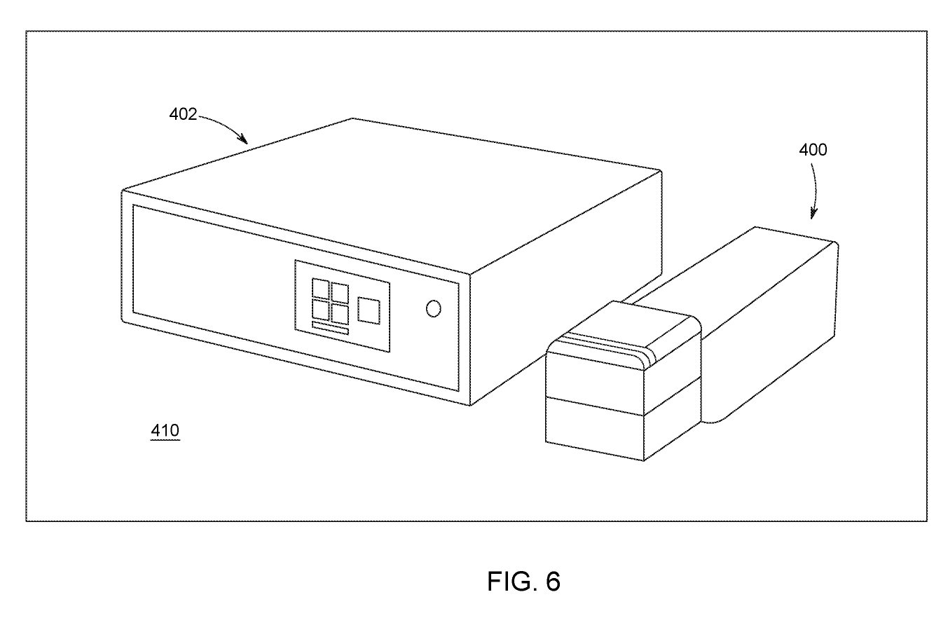

FIG. 6 is a schematic of a torque marking system 410 comprising a fastener marking device 400 and data storage component 402. Marking device 410 and data storage component 402 may be connected wirelessly or via wired connections. Data storage component 402 may be a stand-alone custom-built interface system or it may be an off-the-shelf general purpose computing system. Alternatively, data storage component 402 may interface with the digital torque control 222 via wired or wireless connections in order to update parameters on the tool or receive data from the tool.

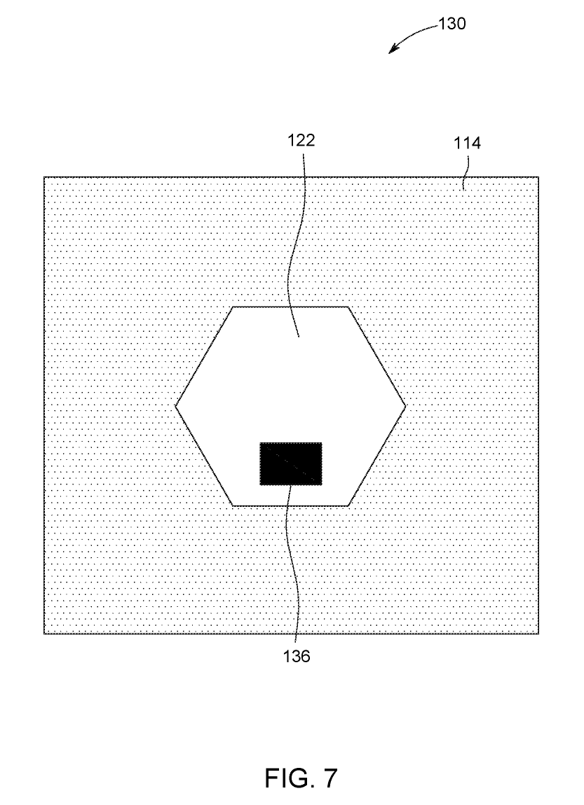

FIG. 7 is a top view of a screw-type fastener 122, in the shape of a hex-head bolt, and adjacent surface 114, wherein a unique identifier 136 is located on the top portion of the fastener. The position of the unique identifier 136 may be aligned with any edge, in the center of the fastener, or placed at an intermediate distance between an edge and a sensor. The unique identifier 136 may be additive to the fastener 122 (i.e., inkjet deposit, application of a tag, marking with a special material, etc.) or it may be subtractive or deformative (i.e., etching of the surface, striking the surface, carving, embossing, etc.).

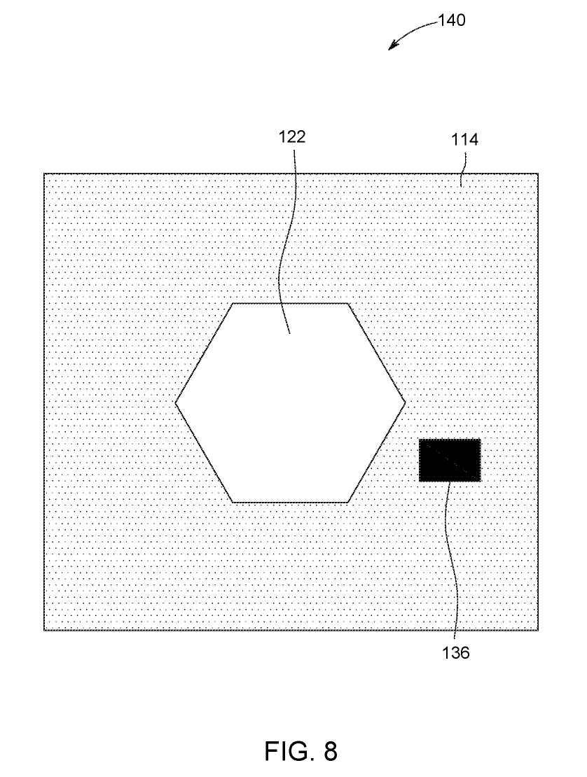

FIG. 8 is a top view of a screw-type fastener 122, in the shape of a hex-head bolt, and adjacent surface 114, wherein a unique identifier 136 is located on the adjacent surface. The unique identifier may also bridge from the fastener 122 to the surface 114 such as the application of a wax fill or paint bridge (not shown). The unique identifier 136 may be aligned with an edge, radially, or in any random orientation; it may be in contact with the fastener or joint edge or spaced away from the edge as shown. The unique identifier 136 may be additive to the adjacent surface 114 (i.e., inkjet deposit, application of a tag, marking with a special material, etc.) or it may be subtractive or deformative (i.e., etching of the surface, striking the surface, carving, embossing, etc.).

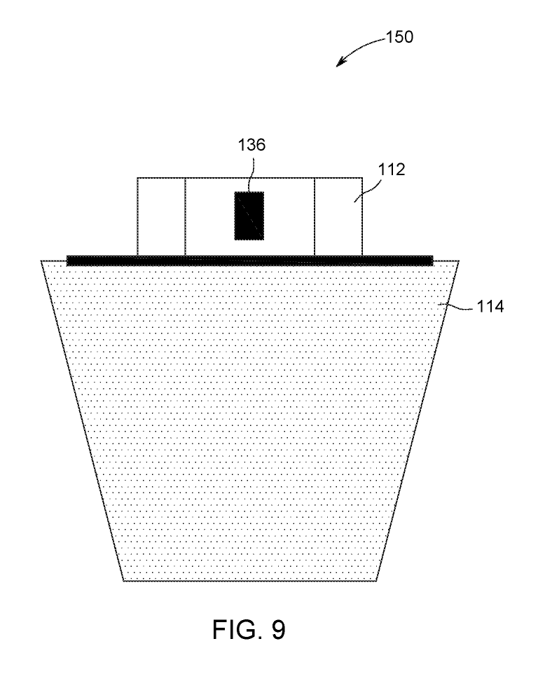

FIG. 9 is a side view of a fastener 112, with vertical side faces, and adjacent medium 114, wherein a unique identifier 136 is located on the side of the fastener. The unique identifier may also bridge from the fastener 112 to the surface 114 such as the application of a wax fill or paint bridge (not shown). The unique identifier 136 may be aligned with an edge, axially to the direction of the fastener as shown, or in any random orientation; it may be in contact with the fastener edge or spaced away from the edge as shown. The unique identifier 112 may bridge from the vertical surface to one or both horizontal surfaces (i.e., top of the fastener or adjacent material). The unique identifier 136 may be additive to the fastener 112 surface (i.e., inkjet deposit, application of a tag, marking with a special material, etc.) or it may be subtractive or deformative (i.e., etching of the surface, striking the surface, carving, embossing, etc.).

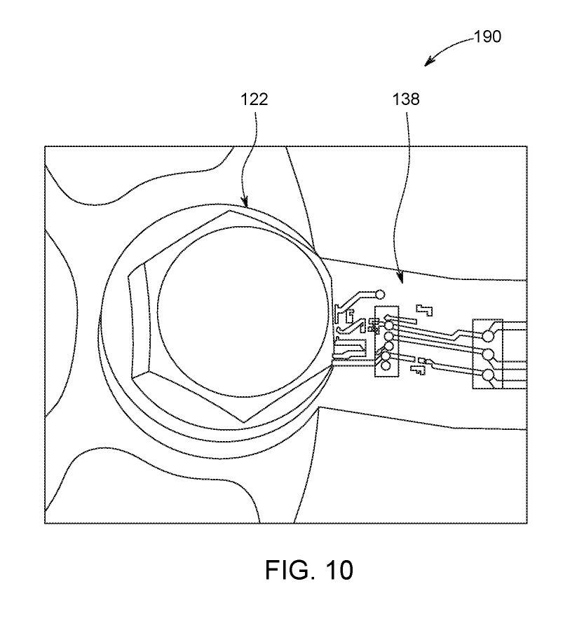

FIG. 10 is a schematic of a screw type fastener 122 in the form of a hex-head bolt with washer, an RFID tag 138 attached to the fastener. RFID tag 138 may be attached to the fastener as shown or may be incorporated into the fastener itself, such as part of the head of fastener 122. RFID tag 138 may be programmed by system 100 or 110 when fastener 122 is at a pre-set torque value (or within range) or it may be pre-programmed with the set value / range. RFID tag 138 may program labeling mechanism 104, digital torque control 222, or fastener element engaging component 102. RFID tag 138 may be updated with new values when maintenance or repair of the screw-type fastener 122 occurs. Alternatively, RFID tag 138 may be coupled to sensors, such as strain or stress gauges (not shown), to monitor joint condition. RFID tag 138 may be passive, or active.

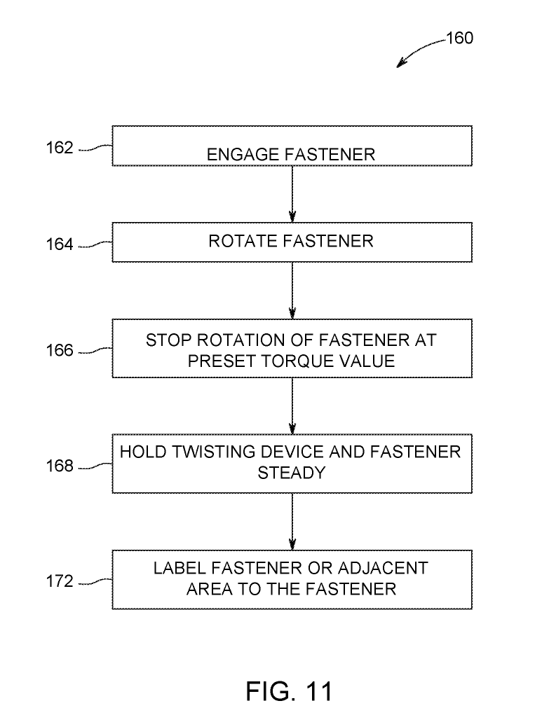

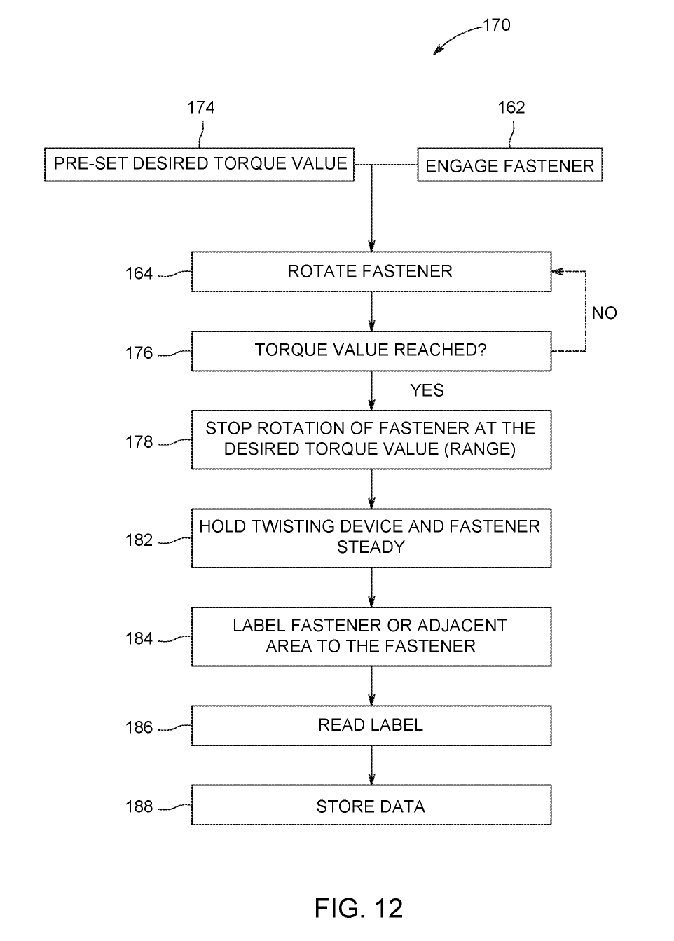

Exemplary non-limiting embodiments of the inventive subject matter further relate to screw-type fastener marking devices and methods. FIGS. 11 and 12 convey screw-type fastener marking methods that can comprise the steps of engaging a fastener element 162, rotating a fastener element with a joint-formation tool equipped with torque-application fastener engaging component 164, stopping the rotation of the fastener element 166, holding the joint formation and marking device and fastener steady 168, and marking the fastener or adjacent medium 172 with a marking device that is attached to the torque-application device. FIG. 12 incorporates the steps of presetting a desired torque value 174 on the joint formation tool, stopping the rotation of the fastener element at the desired torque value/range 178, holding the joint formation and marking device and fastener steady 182, marking the fastener element or adjacent medium/surface 184, reading a mark 186, and storing data related to the mark 188.

Example techniques of creating a mark can include etching information on an adjacent surface to the fastener, for example: with an integrated laser marking system, printing the information using inkjet techniques, or transferring information to an RFID tag that is attached to a fastener. A mark could further be made by modifying the surface of a fastener and/or adjacent surface leaving, for example, a raised profile, indentation and/or combinations thereof. A mark could also be made, for example, through the deposition of a wax, plastic, or similar, seal. A mark could also be made through the application of reflective material or material that changes light transmission or reflection properties with application of torque to the joint.

In the case of an RFID tag, the RFID tag can be a chip, integrated circuit, antenna, etc., and can contain passive or active elements. The RFID tag can contain a dataset composed of information such as, in the case of a screw-type fastener system, the applied torque, tool information, operator identification, and corresponding tolerances. The mark can also incorporate etching information via a barcode, such as a one-dimensional barcode or a two-dimensional barcode (also known colloquially as a “QR Code”). The barcodes can contain a dataset composed of information that can include values such as: the torque, tool information, torque-application device information, operator information, and corresponding tolerances. The barcode and/or RFID tag would remain with the fastener and/or adjacent surface. Alternatively, the integrated marking system can form an RFID tag or tag components into the fastener and/or into the adjacent system. One skilled in the art would recognize that a “mark” or “marking” is any indication present in singular or multiple forms that conveys information that the joint was formed to the appropriate specification and/or the fastener was torqued to a desired torque value or to a torque within a desired torque value range.

The labeling mechanism of any embodiment can be a device that writes to an RFID tag. The device may be an RFID reader that protrudes from the handle of a joint-formation tool or the RFID reader may be embedded within the handle. In most cases, an RFID tag is singulated by an RFID reader following a singulation protocol that identifies a tag with a specific identifier from a number of tags in a field and subsequently either transfers information to or reads information from the tag.

The fastener engaging component of any of the embodiments which encompass screw-type fasteners can be attached to a handle of a joint formation and marking tool similar to a socket attached to a wrench, or it may be embedded within the handle of the joint formation tool. The fastener engagement element of any embodiment can be a wrench, socket, torque wrench, drill, lug wrench, monkey wrench, pipe wrench, pliers, screwdriver, torque screwdriver, DC torque tool, transducerized torque tool, hydraulic torque wrench, clutch controlled torque tools, pulse controlled torque tools, etc.

In any embodiment, a joint formation and marking tool may further comprise a power source. The power source can be an external electrical, battery source, pneumatic (air) power source, hydraulic power source, DC power supply, AC power supply, etc. Energy can be applied through, manual, mechanical, or powered means. The joint formation tool and the labeler may use the same power source, or the joint formation tool and labeler may use separate power sources. Additionally, the joint formation tool may be manual and the labeler may use a power source.

A control of any embodiment can be in communication with the fastener engaging element to communicate and set the desired value or range of a desired process characteristic; in the case of a screw type fastener this can be a torque value or a desired torque range. A marking device can be in communication with the control and configured to mark or label a fastener after the fastener is at the desired process characteristic value, or within the desired process characteristic value range. The mark, for example, can indicate that a fastener was torqued to the desired torque or within a desired torque range. The driver of the joint formation tool can be manual or powered.

A unique identifier of any embodiment can be a radio-frequency identification (RFID) tag or barcode. The barcode may be a one-dimensional barcode type such as Code 128, EAN, UPC, Codabar, or Code 93. The barcode may be a two-dimensional (2D) Barcode Type such as QR CODE, DATAMATRIX CODE, PDF417, AZTEC, or GS1-Data Matrix.

A dataset may be stored in an information-storage location either internal or external to a joint formation tool. The dataset may be stored in a location such as a: computer, computer database, processor with a memory, external hard drive, internet-based storage, cellular device, cloud storage, solid state drive (SSD), network attached storage (NAS), storage area networks (SAN), etc. In certain embodiments the tool and/or reader communicates with the information-storage location in order to transmit the data to the tool and/or reader.

In at least one exemplary non-limiting embodiment, a mark can be scanned after the data is stored and a dataset of information corresponding to the fastener can be determined from scanning the mark. For example, in the context of a screw-type fastener, if something is wrong with the fastener, a mark can be scanned and a torque value of a fastener can be determined, the date the fastener was attached can be determined, and the operator associated with the installation of the fastener can be determined in addition to other pieces of information. The dataset may also include values related to the applied torque, tool information, operator identification and corresponding tolerances. The data may reside with the joint formation and marking device and can provide evidence that assembly requirements were satisfied.

Analog and digital measurement devices that may be used to determine the value of present torque of a fastener among others can include: a torque sensor, torque tester, inline torque tester, dial torque analyzer, mechanical torque loader, torque wrench loader, handheld digital torque gauge, impact wrench torque test system, hydraulic wrench torque tester, electric screwdriver torque tester, air tool and impact wrench digital torque tester, rotary torque transducer, square drive torque sensor, cap torque tester, rotating torque analyzer, etc.

In some embodiments, the joint formation and marking tool could employ laser etching as a method of marking a fastener and/or an adjacent surface. The laser etching can take place after the completion of joint formation. The joint formation and marking tool would hold a steady position for a period of time (approximately 1 second—a minute or more), while the etching of the fastener and/or adjacent surface takes place.

In certain embodiments, the joint formation and marking tool could transmit data to an

RFID tag attached to the fastener as a method of marking the fastener and/or labeling the adjacent surface. The data transmission could take place after completion of fastener rotation. The tool would not need to hold a steady position for the period of time while the writing takes place (approximately 1s).

In embodiments where an RFID tag is used, the RFID tag can be attached to the adjacent surface, or the RFID tag can be attached to the fastener. The RFID tag can be passive, active, or battery-assisted passive. The RFID tag may be read-only or read/write.

Readers for both RFID tags and barcodes may be passive reader active tag (PRAT) readers, active reader passive tag (ARPT) readers, active reader active tag (ARAT) readers, long range barcode scanners, laser barcode scanners, pocket barcode scanners, 2d barcode scanners, 2d wireless barcode scanners, pen barcode scanner, mobile computer, pen-type readers, laser scanners, cd readers (LED scanners), camera-based readers, video camera readers, large field-of-view readers, omnidirectional barcode scanners, cell phone cameras, smartphones, automatic readers, etc.

The dataset of any embodiment might be transmitted via hardwire, Bluetooth, radio frequencies, ultrahigh frequency, high frequency, low frequency, etc. Information in the dataset stored under the unique identifier can amongst others include: torque value; angle; operator ID; the date that the fastener was installed, repaired, modified, or inspected; the time the fastener was installed, repaired, modified, or inspected; information on the fastener; tool information; operator information; corresponding tolerances, etc.

It is understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to those of ordinary skill in the art upon reviewing the above description. The scope of the inventive subject matter should, therefore, be determined with reference to the appended claims, along with the full scope of equivalents to which such claims are entitled.

This written description uses examples to disclose several embodiments of the inventive subject matter and also to enable any person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, the words “including,” “having,” “comprising,” and all derivations thereof should be construed as open-ended transitional phrases and, therefore, use of said phrases herein does not exclude the presence of additional elements or steps relative to those listed in a claim or described in the specification

Since certain changes may be made in the above-described systems and methods, without departing from the spirit and scope of the inventive subject matter herein involved, it is intended that all of the subject matter of the above description or shown in the accompanying drawings shall be interpreted merely as examples illustrating the inventive concept herein and shall not be construed as limiting the inventive subject matter.

What is claimed is:

1. A method for marking a fastener comprising:
rotating a fastener with a torque application device;
stopping the rotation of the fastener;
determining or measuring the torque value of the fastener; and
marking the fastener and/or adjacent surface with a marking device attached to the torque application device.

2. The fastener marking method of claim 1, wherein the fastener or adjacent surface to the fastener is labeled with a unique identifier.

3. The fastener marking method of claim 2, wherein the unique identifier is at least one of: a Radio-frequency identification (RFID) tag, barcode, an actual torque value, and combinations thereof.

4. The fastener marking method of claim 2, further compromising the step of scanning the identifier and determining a dataset of information for the fastener.

5. The fastener marking method of claim 2, wherein the unique identifier contains a dataset of information.

6. The fastener marking device of claim 5, wherein the dataset of information includes at least one of or a combination of values for: the applied torque tool, tool information, operator information, and corresponding tolerances.

7. The fastener marking method of claim 5, further compromising the step of storing the dataset in an external location.

8. The fastener marking method of claim 1, wherein the rotation of the fastener is stopped when the within a desired torque range and/or at a desired torque value.

9. The fastener marking method of claim 8, wherein marking the fastener and/or adjacent surface with a marking device attached to the torque application device occurs only when the torque value is within the desired torque range and/or at a desired torque value.

10. A fastener torque application and marking device comprising;
a torque application device configured to rotate a fastener;
a torque measuring mechanism attached to the torque application device,
a marking mechanism attached to the torque-application device, wherein the marking mechanism is configured to mark the fastener with a unique identifier when desired torque is reached; and
a reader that reads the unique identifier and confirms proper torque application.

11. The fastener torque application and marking device of claim 10, further comprising a power source.

12. The fastener torque application and marking device of claim 11, wherein the power source is an electric power source, a battery, a pneumatic power source, or a hydraulic power source.

13. The fastener torque application and marking device of claim 10, further comprising a computer database.

14. The fastener torque application and marking device of claim 13, wherein the tool and/or reader communicates with the computer database.

15. The fastener torque application and marking device of claim 10, wherein the fastener and/or adjacent medium to the fastener is labeled with a unique identifier such as an RFID tag, barcode, or the actual torque value.

16. A torque application tool comprising:
a fastener engaging component configured to engage and torque a fastener;
a torque control in communication with the fastener engaging component configured to limit the torque output of the fastener engaging component to a desired torque and/or to a torque within a desired torque range; and
a marking mechanism in communication with the torque control configured to mark the fastener after the fastener is torqued to the desired torque and/or within the desired torque range;
said mark indicating that the fastener was torqued to the desired torque and/or within the desired torque range.

17. The torque application tool of claim 16, further comprising a reader.

18. The torque application tool of claim 16, wherein the mark is a unique identifier.

19. The torque application tool of claim 16, further comprising a power source.

20. The torque application tool of claim 16, further comprising a database.
